(19) United States
(12) Patent Application Publication
(10) Pub. No.: US 2025/0088695 A1
(43) Pub. Date: Mar. 13, 2025

(54) DEVICE AND METHOD FOR CAPTURING THE ATTENTION OF A VIEWER

(71) Applicant: fm marketing gmbh, Neumarkt am Wallersee (AT)

(72) Inventors: Ferdinand Maier, Neumarkt am Wallersee (AT); Chris Langdon, Burnaby (CA)

(21) Appl. No.: 18/829,740

(22) Filed: Sep. 10, 2024

(30) Foreign Application Priority Data
Sep. 11, 2023 (DE) 10 2023 124 470.1

(51) Int. Cl. H04N 21/422

(52) U.S. Cl. CPC H04N 21/4221; H04N 21/42215

(57) ABSTRACT

The invention relates to a device for capturing the attention of a viewer of a multimedia media playback played on a screen with a remote control when a request to the viewer to press a call-to-action button, called CTA button, of the remote control is displayed on the screen, comprising a clock for creating a touch time stamp when the viewer touches the CTA button on the remote control, for creating a release time stamp when the viewer finishes touching the CTA button on the remote control, and for creating a trigger time stamp when the viewer presses the CTA button on the remote control.

### TECHNICAL FIELD

The present invention relates to a device for capturing the attention of a viewer, a remote control for connection to the device and a system comprising the device and the remote control.

### BACKGROUND

US 2015/0100167 A1 discloses a smart home system with a remote control on which special buttons called lens buttons are arranged with a transparent surface. In addition to entering commands, they can also serve as visual indicators. A light ring installed behind the buttons can indicate the status of smart devices. The smart home system also includes a hazard detector with seven different sensors, including smoke, heat and carbon monoxide sensors for triggering alarm signals and issuing voice messages with calls to action to inform a user what type of hazard (e.g. smoke or carbon monoxide) has been detected and where this hazard is located (e.g. in the living room or bedroom). The calls to action contain specific instructions for further action, such as “Leave the room now” or “Get some fresh air”.

US 2018/0098109 A1 discloses a system in which a remote control with a touch screen is used to control an image display device. The remote control displays various device settings and functions, enables precise micro-control and reduces the number of physical buttons compared to conventional remote controls. Interactions between the remote control and the image display device are local, with the remote control being capable of receiving complex user commands and executing corresponding functions on the image display device. Detecting the duration of a button press enables the remote control to distinguish between different types of inputs (e.g. short vs. long button press) and trigger different functions accordingly.

US 2015/0121412 A1 discloses a system for controlling notifications on internet-enabled television sets and other connected multimedia devices to enhance the viewer experience. The system allows the user to suppress or control unwanted notifications that may be distracting while watching television. This is achieved through various methods such as long pressing buttons on the remote control, double clicking the mute button or using a special notification mute button. The purpose of controlling and suppressing notifications is to preserve the viewer's immersion in the television content and minimize distractions.

Time stamps can be captured to recognize long button presses and thus suppress notifications for a certain time or until the button is pressed again. The publication MDN Web Docs—Performance API—PerformancePaintTiming dated 7 Jul. 2023 available at the URL https://developer.mozilla.org/en-US/docs/Web/API/PerformancePaintTiming discloses the PerformancePaintTiming API, which captures time stamps for rendering content on a web page. In particular, it records the time of the first rendering (first paint) and the time of the first rendering of textual or image content (first contentful paint). This information is used to improve the responsiveness and performance of a website by minimizing the time it takes for users to see content.

### SUMMARY

It is the object of the invention to improve the known system.

The task is fulfilled by the characteristics of the independent claims. Preferred embodiments are the subject matter of the dependent claims.

According to one aspect of the invention, a device for capturing the attention of a viewer of a multimedia media playback played on a screen with a remote control when a request to the viewer to press a call-to-action button, called CTA button, of the remote control is displayed on the screen, comprises a clock for creating a touch time stamp when the viewer touches the CTA button on the remote control, the creation of a release time stamp when the viewer finishes touching the CTA button on the remote control, and the creation of a trigger time stamp when the viewer presses the CTA button on the remote control.

A call-to-action button, hereafter referred to as CTA button, is a button on a remote control or an interactive button in a user interface that is used to prompt or direct the user to take a specific action. These buttons are usually designed to be eye-catching and may contain short, concise texts that prompts the user to interact, such as “Get help now”, “Raise alarm” or “Send emergency call” etc. The CTA button comes as a configuration element from the design of websites, apps and other user interfaces and plays a decisive role in user guidance and conversion optimization. A click on the CTA button usually achieves a specific goal, for example alerting the nearest emergency services, automatically making a predefined emergency call or initiating special safety protocols. In the context of the invention described below, the CTA button should not be understood in a restrictive way.

This specified device is based on the idea that it is necessary not only to determine whether a viewer perceives certain messages, but also to obtain clues as to how the message was received by the viewer. For example, messages warning of an impending disaster are by nature highly emotional and urgent. Communicating them quickly and accurately can save lives and help affected communities prepare and respond appropriately. The specified device allows media organizations to develop a deeper understanding of how individuals react to such news.

The touch time stamp provides valuable data on the speed of audience response to information or prompts presented. Even if a viewer ultimately chooses not to press the CTA button, the mere touch provides an indication of their attention and interest in the message.

The linking of the touch and release time stamp also allows conclusions to be drawn about the duration of the viewer's decision-making process. Every decision first requires the perception of information—in this case the multimedia presentation that prompts the viewer to confirm via the CTA button. This information is processed in the brain and compared with existing knowledge, experiences and memories. The brain evaluates the available options and makes a selection. This process can take place on both a conscious and unconscious level. The result manifests itself in the viewer's actions: pressing or not pressing the CTA button.

This behavior provides valuable data for future multimedia presentations and allows content to be better aligned with the viewers' decision-making processes. Emotions are known to be a strong influencing factor for decisions, as they can affect the attractiveness or rejection of options. By adapting emotional content in multimedia presentations and then measuring the reactions to it, their effectiveness can be better assessed.

Such data also offers insights into the cognitive biases of the viewer that influence their information processing and reaction. Conclusions can also be drawn about social and environmental influencing factors, such as peer pressure, social norms or cultural expectations. In particular, ignoring a request can provide valuable insights into group dynamics. This is particularly invaluable in the communication of emergency messages as it can potentially save lives.

In a further embodiment of the disclosed device, the display instruction comprises displaying the CTA button on the screen. In this way, a visible representation of the CTA button is enabled on the screen, which serves as a visual confirmation for the viewer. This is particularly helpful when the remote control has multiple buttons or the design of the CTA button is not immediately recognizable. The direct visual correlation between what is displayed on the screen and what the viewer is expected to do increases the likelihood of a correct and quick response. The display of the CTA button on the screen also draws the viewer's attention directly to the desired action and reduces potential distractions or confusion. It represents an intuitive “instruction for action” that noticeably simplifies the viewer's decision-making process. By visually perceiving the CTA button in the context of the message or information, the viewer can also better understand the context. This is particularly important when there are several possible actions or reactions to the message.

The visual representation of the CTA button can also be used to create an emotional response or connection. For example, the button could be represented in a color or shape that signals urgency, importance or other emotions. Seeing a physical action represented on the screen also reinforces a sense of interactivity and participation for the viewer. It creates a sense of involvement and thus increases the viewer's participation and reaction. If there is additional information or instructions associated with the CTA button, these can be presented directly next to the visually presented button, providing clarity and reducing potential misunderstandings.

In a further embodiment, the specified device comprises a communication interface arranged to send a change instruction to the remote control, requesting the viewer to press the CTA button and change the appearance of the CTA button. In this way, changes, especially visual or haptic, are used to draw the user's attention to the CTA button. If the CTA button lights up, vibrates, is raised above the button image, or in any way begins to change from its normal state, the viewer is likely to respond more quickly as these changes are difficult to miss or over-feel. Depending on the speed of the state change, for example with a rapid flashing or vibrating of the CTA button, the urgency or importance is signaled. This is particularly useful when an immediate response from the viewer is required, for example in the case of emergency messages. One way to change the state of the CTA button from its normal state is a tactile change, such as raising the button, which provides the user with a physically perceptible aid in recognizing the CTA button. In addition, people with impaired vision or other impairments can benefit from haptic or acoustic changes, as they are not exclusively dependent on visual cues. By changing the state of the CTA button depending on the prompt to press the CTA button, a clearly perceptible distinction can be made between different types of prompts or messages. Changing the CTA button also increases the sense of interactivity and participation for the viewer. It creates a more dynamic user experience and can therefore increase viewer engagement and response. Haptic or visual stimuli influence the viewer's decision-making process. For example, a pleasant glow or vibration could evoke positive associations and make the user more likely to press the button. Finally, the way in which the CTA button is changed can vary depending on the context or objective of the message. This provides flexibility and allows the user experience to be optimized depending on the situation.

In an additional embodiment of the specified device, the change instruction comprises an appearance of the CTA button to be updated. Preferably, updating the appearance of the CTA button can be thematically aligned with the content of the media playback being played on the screen. When the CTA button changes its appearance to match the content of the message, such as a rain cloud in a severe weather warning, a clear and direct link is immediately established between what is shown on the screen and what is expected by the viewer. An intuitive and thematically appropriate appearance shortens the processing time in the brain of the viewer. Instead of interpreting an abstract button, the viewer will immediately know what action is expected through the updated appearance of the CTA button. A thematically appropriate symbol can evoke stronger emotional responses than a generic button. In the rain cloud example, this can increase the sense of urgency and importance, which can increase the likelihood of a response. For people who have difficulty reading or understanding text, visual symbols can provide a clearer and more immediate form of communication. A themed design increases usability and leads to a more positive user experience as it shows that the designer of the media rendition has carefully considered the content and user journey. An image or symbol is often universally understood, thus overcoming language barriers. This can be particularly important if the media playback is intended for a multicultural or multilingual audience. People also tend to retain visual information better than text-based information. A memorable icon on the CTA button helps the viewer remember the message and the associated prompt. An updated appearance of the CTA button that matches the content on the screen creates a consistent and harmonious user experience. This helps to avoid confusion or frustration.

In another embodiment of the specified device, the communication interface is further configured to receive a motion signal from the remote control indicating a movement of the remote control. Based on the motion signal, the clock is configured to create a motion time stamp documenting the start of the movement. Taking into account the motion signal sent by the remote control and documenting the start of a movement significantly improves the capture of the viewer's attention. People often react to a stimulus (e.g. a multimedia message on the screen) first with a physical movement, even before they make a conscious decision. The motion signal indicating the movement of the remote control can therefore be the first sign that the viewer is reacting to the message, even before they touch the CTA button. If the viewer moves the remote control immediately after the prompt to press the CTA button, but neither touches nor presses the CTA button, this could indicate hesitation or uncertainty. This information can be used as a further criterion to assess how the viewer perceives the message and how effective the message is in terms of the desired response. If the viewer moves the remote control immediately in anticipation of an action, this indicates that their attention is strongly focused on the screen and the message. In other words, if the viewer takes a comparatively long time to pick up the remote control to press the CTA button, this could indicate that the prompt to press the CTA button or the entire multimedia media playback being played was misleading and the viewer understood the content rather accidentally. This can serve as a further indicator of the effectiveness of the multimedia playback. The longer the time between the motion time stamp and the touching or pressing of the CTA button, the more complex the decision making could be for the viewer, indicating that additional clarity or information is required. The combination of motion, touch and release time stamps also allows for a more detailed and comprehensive picture of the viewer's reaction and interaction. This leads to a more precise analysis and interpretation of the data. Even if the viewer ultimately decides not to press the CTA button, the mere movement of the remote control in response to the prompt to press the CTA button can be interpreted as a sign of engagement or interest. As indicated above, capturing such subtle signals can help to deepen the understanding of what appeals and engages the viewer or not. By capturing the motion data, it is possible to determine how intuitive the prompt or message is to the viewer. For example, depending on how many viewers move the remote control immediately after the said prompt, it can be deduced how clear and easy to understand the prompt was. Taking the motion signal into account significantly improves the ability of the specified device to measure the attention, engagement and response of the viewer. This leads to a deeper and more accurate insight into the viewer's behavior and the effectiveness of the message or prompt.

In a particular embodiment of the specified device, based on the motion signal, the clock is further configured to create a rest time stamp documenting the end of the movement. The rest time stamp documenting the end of the movement extends the depth of the data and provides additional insight into the behavior and attention of the viewer. The motion and rest time stamp can be used to determine the exact duration in which the viewer was actively engaged or attentive. This can provide information about how strongly the viewer was focused on the multimedia media playback being played on the screen and how effectively it was able to attract the viewer's attention. For example, if there is a long period of time between the start of movement and rest, and if the user has held the remote control in their hand for a long time without pressing the CTA button, this could indicate that the viewer was distracted or their attention was focused elsewhere. Put another way, a short period between the start of movement and rest, which includes the activation of the CTA button, may indicate a high level of engagement and determination. This data, obtained from the combination of motion, rest, touch and release time stamps, can be used to optimize multimedia content. For example, if it is found that many viewers pick up the remote control and hold it in their hand for an extended period of time without pressing the CTA button, this could indicate that the content needs to be reworked to be more effective. By knowing how long viewers hold the remote control in their hand and whether they end up pressing the CTA button, call-to-action instructions can be fine-tuned to be more effective. In combination with other data, these time stamps can therefore be used to paint a more comprehensive picture of viewer behavior. For example, a rest time stamp placed in the emotional context of the multimedia media playback can be used to infer the extent to which the viewer was touched by the scene, which in turn can be used to infer whether the instruction to press the CTA button was given at the right time. Overall, the introduction of a rest time stamp, which documents the end of the movement of the remote control, allows a more precise and in-depth recording of the attention and reaction of the viewer. This can provide valuable insights for content creators, advertisers and other stakeholders depending on what the CTA button is used for.

In yet another embodiment of the specified device, the clock is further configured to create a presentation time stamp documenting when the prompt was displayed to the viewer. By comparing the presentation time stamp with the motion time stamp, it is possible to determine how quickly the viewer responded to the prompt to press the CTA button. A quick reaction would indicate a high level of attention and interest. In other words, if the viewer holds the remote control in their hand for an extended period of time before reacting, this indicates that they are thinking about the information or prompt presented. This can provide valuable information about what content or prompts may be causing uncertainty or concern for the viewer. Additionally, if it is determined that a group of viewers tends to respond faster or slower to certain types of prompts (based on the time between presentation and motion time stamps), this can be used to determine the optimal timing for future prompts. The total time the viewer holds the remote control in their hand, in combination with the time the prompt is presented, can be used to evaluate the overall effectiveness of multimedia media playback. This is particularly useful for advertisers or content creators who want to measure the success of their messages. The time span between the presentation time stamp and the motion time stamp can be used as a basis of information to determine the viewer's level of distraction. This can then be used to introduce improvements to the prompt to press the CTA button, with the aim of speeding up the viewer's response. Understanding how long viewers typically take to respond to a prompt and how long they remain engaged (holding the remote control in their hand) provides valuable feedback for content creators to optimize and make multimedia content more effective.

In a further embodiment of the specified device, the clock is further adapted to create a fade-out time stamp that documents when the displayed prompt to the viewer has been faded out again. The introduction of a fade-out time stamp, which records the time when the displayed prompt to the viewer is faded out again, offers additional advantages and possibilities for analyzing and interpreting viewer reactions. By comparing the presentation time stamp with the fade-out time stamp, the exact duration of how long the prompt was displayed on the screen can be determined. This provides insight into the average time that is considered effective for such prompts. The time between the prompt being displayed and fading out, compared to the viewer's reaction time (between presentation time stamp and motion time stamp), provides insight into how effective a prompt was. For example, if viewers react quickly before the prompt fades out, this indicates an effective prompt. The fade-out time stamp can be used to determine whether the viewer made their decision (i.e. pressing the CTA button) while the prompt was still displayed or afterwards. This can help to understand whether the decision was made spontaneously based on the prompt or whether the viewer needed more time to think about it. It is also possible to deduce how well the viewer was able to remember the prompt, if applicable, and how concise it was for their memory. Put another way, if it is found that many viewers only react after the prompt has faded out, this could indicate that the prompt should be displayed for longer. Conversely, if most viewers respond quickly, the prompt duration could be shortened to optimize the flow of media playback. By understanding when viewers typically respond (before or after the prompt fades out), content creators can adjust their prompting strategies to maximize interaction and engagement. In summary, the fade-out time stamp allows for a more accurate analysis of the effectiveness of prompts and provides valuable data to optimize the presentation and timing of such prompts to maximize the attention and engagement of the viewer.

According to another aspect of the invention, a method for capturing the attention of a viewer of a multimedia media playback played on a screen comprises the steps of presenting a prompt to the viewer on the screen to press a call-to-action button (CTA button) of the remote control, creating a touch time stamp when the viewer touches the CTA button on the remote control, creating a release time stamp when the viewer finishes touching the CTA button on the remote control, and creating a trigger time stamp when the viewer presses the CTA button on the remote control.

In a further embodiment, the specified method comprises the step of displaying the CTA button on the screen.

In a further embodiment, the specified method comprises the step of sending a change instruction to the remote control to change the appearance of the CTA button, wherein the request is sent to the viewer to press the CTA button.

In a further embodiment of the specified method, the change instruction comprises updating the appearance of the CTA button.

In a further embodiment, the specified method comprises the steps of receiving a motion signal from the remote control indicating a movement of the remote control and creating a motion time stamp documenting the start of the movement based on the motion signal.

In a further embodiment, the specified method comprises the step of creating a rest time stamp documenting the end of the movement based on the motion signal.

In a further embodiment, the specified method comprises the step of creating a presentation time stamp documenting when the prompt to the viewer has been displayed.

In a further embodiment, the specified method comprises the step of creating a fade-out time stamp documenting when the displayed prompt to the viewer has been faded out again.

According to a further aspect of the invention, a control device is arranged to implement one of the specified methods.

In a further embodiment of the specified device, the specified device comprises a memory and a processor. The specified method is saved in the memory in the form of a computer program, and the processor is provided for executing the method when the computer program is loaded from the memory into the processor.

According to another aspect of the invention, a computer program comprises program code tools for executing all the steps of the specified method when the computer program is executed on an electronic device or one of the specified devices.

According to another aspect of the invention, a computer program product contains a program code which is saved on a computer-readable data carrier, and which carries out the specified method when it is executed on a data processing device.

### BRIEF DESCRIPTION OF FIGURES

FIG. 1 shows a schematic representation of a system comprising a television set and a remote control.

FIG. 2 shows a schematic representation of a network with the system from FIG. 1,

FIG. 3 is a sequence diagram of a process in the network shown in FIG. 2.

In the figures, the same technical elements are provided with the same reference signs, and are only described once. The figures are purely schematic and, in particular, do not reflect the actual geometric proportions.

### DETAILED DESCRIPTION

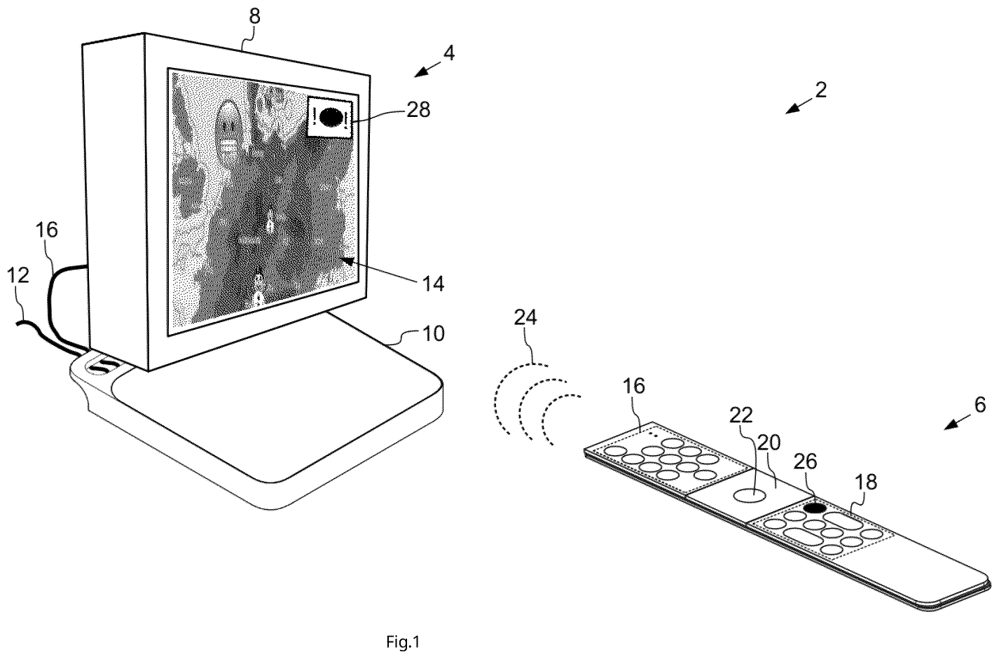

Reference is made to FIG. 1, which shows a schematic representation of a system 2 comprising a television set 4 and a remote control 6.

The television set 4 comprises a screen 8 to which a set-top box 10 is connected. The set-top box 10 receives a data stream containing a video 14 via a network connection 12, which is shown as a network cable in FIG. 1 as an example. The set-top box 10 filters the video 14 from the data stream and outputs a video signal carrying the video 14 to the screen 8 via a screen cable 16 in order to display the video 14 on the screen 8.

Before the video 14 is discussed in more detail, the control of the television set 4 using the remote control 6 will be discussed first.

The remote control 6 comprises a first keypad 16 and a second keypad 18, which are separated from each other by a directional pad 20. A confirmation button 22 is located in the center of the directional pad 20. This structure is basically known and does not need to be explained further. The buttons of the keypads 16, 18 as well as the directional pad 20 and the confirmation button 22 are used to enter control commands in order to control the function of the television set 4. For this purpose, the inputs are sent in a transmission signal 24 to the set-top box 10, which filters the inputs from the transmission signal 24 and then performs functions on the television set 4 corresponding to the inputs, such as volume control, program selection and the like.

A special button on the remote control, which is hatched in FIG. 1 and provided with the reference sign 26, is used for a special function on the television set 4. The idea is to execute this as a call-to-action button, hereinafter referred to as CTA button 26, and to motivate or guide the viewer and thus user of the remote control 6 to a specific action. In the present embodiment, the specific action is exemplary in connection with the video 14, which is executed as a weather report announcing severe weather in the form of a cold wave. The purpose of the specific action is for the viewer to actively confirm that they have taken note of the severe weather reported in the weather report. To this end, the viewer is prompted with a corresponding image 28 of the CTA button 26, which is superimposed on the video 14.

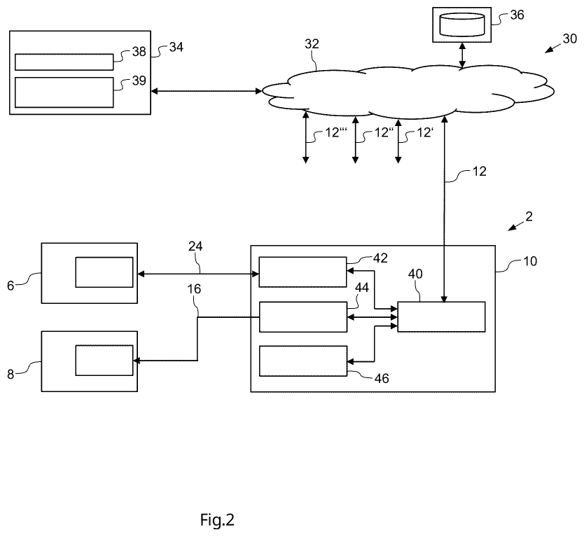

To explain an implementation of this idea, reference is made to FIG. 2, which shows a network 30 in which the system 2 from FIG. 1 is integrated alongside other similar systems not shown. These other integrated systems are indicated in FIG. 2 by further network connections 12′, 12″ and 12′″.

The system 2 and the other systems are connected to each other in the network 30 via bidirectional network connections as network connections 12, which can be realized, for example, via the Internet 32. The network connections should be as fail-safe as possible, which can be achieved for example through redundancy and/or by a satellite network connection, as provided by the company Starlink. In addition, a programming system 34 and a control system 36 are integrated into the network 30, which together implement the above-mentioned idea behind the CTA button 26. Distinguished therefrom, the system 2 described above is hereinafter referred to as subscriber system 2.

The programming system 34 is used below to define and manage so-called campaigns. A campaign is hereinafter to be understood as an organized action or series of actions to motivate the viewers of the video 14 or other videos on the screen 8 to press the CTA button 26, with the aim of confirming their awareness of the severe weather. However, a campaign within the meaning of the disclosure may also have other objectives, such as promoting a product or service, an idea, or a political agenda. To define or control a campaign, a content management system called CMS 38 is implemented in the control system 34, which an operator can use to carry out the necessary programming steps. Programming is a known skill and depends on the programming language selected. Therefore, we will not go into further detail here.

The most efficient way to implement the system is with a subscriber system in which interested participants register. The main advantage of this is that it also avoids data protection problems that arise when participants' data is collected in a way that is necessary for the implementation of the aforementioned idea. A further advantage of the subscriber system is that participants can be specifically addressed if the severe weather message in the video 14 concerns them. For this purpose, a subscriber management system 39 is available in the control system 34, with which the participants can be entered, managed and, if necessary, deleted. To uniquely identify a participant, the identification of the set-top box 10, an identification of the remote control 4 and an identification of the household that owns the system 2 can be stored in the subscriber management system 39, for example.

A campaign is controlled, however, by the control system 36. Here, the campaigns programmed by the programming system 34 are managed and, if necessary, provided with predetermined parameters when a campaign is started. In the case of the severe weather warning mentioned above, for example, this can be a completion of information texts stored in advance as text modules with data such as expected temperature and time and similar. Furthermore, when a campaign is started, the group of participants to be addressed by the campaign is determined, for example, on the basis of the identification of the set-top box 10. Such a group of participants shall be referred to below as a cohort. The control system 36 is further responsible for sending the campaign data, such as an identification of the campaign, media data, texts, and so on, to the individual set-top boxes 10. In order to evaluate a campaign, the control system 36 can also receive evaluation data from the individual participants of the cohort, which primarily comprises feedback on which remote control 6 the CTA button 26 was operated. Finally, the control system 36 can also be used to perform evaluations, such as the A/B testing known per se.

The control system 36 addresses a campaign management service 40 via the network connection 12 in the set-top box 10 of the respective subscriber system 2, which controls the respective campaign started on the side of the participant in the subscriber system 2. The campaign management service 40 can in principle be designed as a physically separate unit, for example to supplement older set-top boxes with the functionality according to the idea described. Alternatively, the campaign management service 40 can also be stored in the set-top box 10 as a program, which would be preferred for cost reasons. In order to manage a campaign on the subscriber side, the campaign management service 40 stores the above-mentioned campaign data and provides important information about the household addressed by the campaign for the evaluation of the campaign. In the case of the severe weather warning above, such information may be, for example, the age of the household members or similar in order to be able to estimate from the reaction of the participant or viewer, how urgent any emergency measures are in the event that the CTA button 26 is not pressed.

The campaign management service 40 also addresses the other components of the set-top box 10 to control the campaign. In the present case, this would be an attention sensor 42 with a communication interface to the remote control 6 designed as a Bluetooth Low Energy interface called BLE interface, a communication interface to the screen 8 designed as a High-Definition Multimedia Interface called HDMI interface 44 and the actual operating system of the set-top box 10, which is generally but not restrictively designed as an Android operating system 46. The attention sensor 42 will be described in more detail later.

Via the BLE interface of the attention sensor 42, the campaign management service 40 sends the request to press the CTA button 26 in the transmission signal 24 to the viewer or subscriber. For this purpose, the CTA button 26 can preferably be designed to be variable, whereby the campaign management service 40 can send an image in addition to or instead of the request as to how the CTA button 26 is to be designed in a particular way for the campaign. Upon sending, the campaign management service 40 waits for a response from the remote control 6 as to whether the CTA button 26 on the remote control 6 has been pressed. In the event of a response, the campaign management service 40 may capture a time stamp documenting the actuation of the CTA button, which is hereinafter referred to as a RCU event (remote control unit event). Alternatively or additionally, the campaign management service 40 may also capture a time stamp documenting where the video is located. In contrast to the RCU event, this event is referred to as a DMB event (digital multimedia broadcasting event). Although the BLE interface of the attention sensor 42 can in principle use any transmission protocol, the corresponding interface must be designed for bidirectional communication.

In contrast, bidirectional communication is not absolutely necessary for the HDMI interface 44. Here, the campaign management service 40 only sends data to the screen 8 without waiting for a response. When starting a campaign, the data sent to the screen 8 includes the request to press the CTA button 26, which in FIG. 1 takes the form of the illustration 28 of the CTA button 26 on the screen 8 and is superimposed on the video 14. In addition, the campaign management service 40 can also transmit background information on a campaign and other data to the screen 8 for display via the HDMI interface 44, if this is necessary. Finally, the campaign management service 40 hides all of this data again at an appropriate time, for example after the CTA button 26 has been pressed or after a campaign has ended.

Finally, the campaign management service 40 may also alter the Android operating system 46, for example, in order to automatically playback videos, start programs or install or establish communication channels, for example to establish a telephone connection. This is to be selected depending on the application purpose. In the case of the severe weather warning mentioned above, for example, a video communication link can be established if the subscriber exceeds a certain threshold age and is expected to need help, in order to then coordinate this help by telephone.

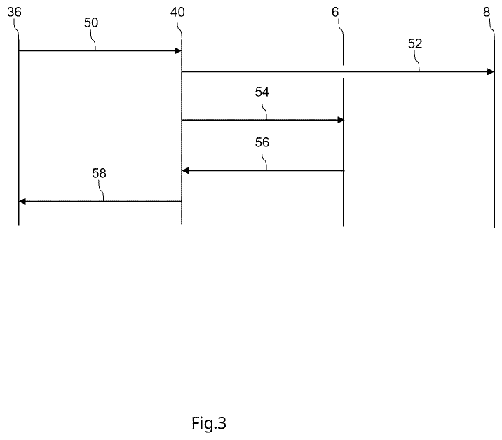

Reference should be made to the sequence diagram in FIG. 3 to illustrate the flow of messages during a campaign.

First, the control system 36 sends a push message 50 to the campaign management service 40 in the set-top box 10, which contains all the information required to present a campaign to the viewer or subscriber and to prompt them to press the CTA button 26. In response to this push message 50, the campaign management service 40 generates a push command 52 and a configuration instruction 54. In addition to optional background information on the campaign, for example the severe weather warning, the push command 52 contains the image 28 of the CTA button 26, which is to be superimposed with the video 14, as a request to press the CTA button 26 and is sent to the screen 8. In parallel, the configuration instruction 54 also contains the image 28 of the CTA button 26 with the instruction to the remote control to design it in a corresponding manner. Alternatively, however, the configuration instruction may also deviate from the image and, for example, only illuminate the CTA button 26 or the like.

Subsequently, the campaign management service 40 waits for a feedback 56 from the remote control 6 as to whether the CTA button 26 has actually been operated and, upon receipt of the feedback 56, sends a feedback message 58 to the control system to confirm the operation of the CTA button.

Finally, the attention sensor 42 as a device for detecting the attention of the viewer of the multimedia media playback 14 played on the screen 4 using the remote control 6 is explained in more detail.

The attention sensor 42 comprises a clock 60. The clock 60 creates various time stamps that are used to document various events. The most important time stamps are a touch time stamp, which documents when the viewer touches the CTA button 26 on the remote control, and a release time stamp, which documents when the viewer stops touching the CTA button on the remote control. The clock also creates a trigger time stamp when the viewer presses the CTA button 26 on the remote control.

Via the BLE interface, the attention sensor 42 receives a motion signal from the remote control 4 indicating a movement of the remote control 4. Based on this motion signal, the clock 60 creates a motion time stamp that documents the start of the movement. Based on the motion signal, the clock 60 is also configured to create a rest time stamp that documents the end of the movement.

The clock 60 is further configured to create a presentation time stamp that documents when the request to the viewer has been displayed and a fade-out time stamp that documents when the displayed request to the viewer has been faded out again.

1. A device for capturing the attention of a viewer of a multimedia media playback played on a screen with a remote control when a request to the viewer to press a call-to-action (CTA) button of the remote control is displayed on the screen, comprising a clock configured to create a touch time stamp when the viewer touches the CTA button on the remote control, configured to a release time stamp when the viewer finishes touching the CTA button on the remote control, and configured to a trigger time stamp when the viewer presses the CTA button on the remote control.

2. The device of claim 1, wherein the request to the viewer comprises a configuration instruction to display the CTA button on the screen.

3. The device of claim 1, comprising a communication interface arranged to send a change instruction to the remote control, requesting the viewer to press the CTA button and change the appearance of the CTA button, wherein the change instruction preferably comprises an appearance of the CTA button to be updated.

4. The device of claim 3, wherein the communication interface is further configured to receive a motion signal from the remote control indicating a movement of the remote control, and wherein the clock, based on the motion signal, is configured to create a motion time stamp documenting the start of the movement.

5. The device of claim 4, wherein the clock, based on the motion signal, is further configured to create a rest time stamp documenting the end of the movement.

6. The device of claim 1, wherein the clock is further configured to create a presentation time stamp documenting when the prompt was displayed to the viewer.

7. The device of claim 6, wherein the clock is further configured to create a fade-out time stamp documenting when the prompt to the viewer was faded out again.

8. A remote control configured to interact with the device of claim 1, comprising: a CTA button having a touch sensor for detecting a touch of the CTA button by the viewer and a pressure pick-up sensor for detecting an activation of the CTA button by the viewer, and a communication interface for sending the sensor signals from the touch sensor and the pressure pick-up sensor to a communication interface of the remote control.

9. A system comprising: the device of claim 1, and a remote control configured to interact with the device, wherein the remote control comprises a CTA button having a touch sensor for detecting a touch of the CTA button by the viewer and a pressure pick-up sensor for detecting an activation of the CTA button by the viewer, and a communication interface for sending the sensor signals from the touch sensor and the pressure pick-up sensor to a communication interface of the remote control.

10. A method for capturing the attention of a viewer of a multimedia media playback played on a screen, comprising the steps of: presenting a prompt to the viewer on the screen to press a call-to-action button of the remote control, called CTA button below, creating a touch time stamp when the viewer touches the CTA button on the remote control, creating a release time stamp when the viewer finishes touching the CTA button on the remote control, and creating a trigger time stamp when the viewer presses the CTA button on the remote control.

11. The method of claim 10, comprising displaying the CTA button on the screen.

12. The method of claim 10, comprising sending a change instruction to the remote control to change the appearance of the CTA button, wherein the request is sent to the viewer to press the CTA button, wherein the change instruction preferably comprises updating the appearance of the CTA button.

13. The method of claim 12, comprising the steps: receiving a motion signal from the remote control indicating a movement of the remote control, and creating a motion time stamp documenting the start of the movement based on the motion signal.

14. The method of claim 13, comprising creating a rest time stamp documenting the end of the movement based on the motion signal.

15. The method of claim 11, comprising:
creating a presentation time stamp documenting when the prompt to the viewer has been displayed, and/or
creating a fade-out time stamp documenting when the displayed prompt to the viewer has been faded out again.
